(19) United States
(12) Patent Application Publication
(10) Pub. No.: US 2015/0029262 A1
(43) Pub. Date: Jan. 29, 2015

(54) TWO-DIMENSIONAL METHOD FOR INKJET PRINTING WITH PRINTHEAD ALIGNMENT

(71) Applicant: Durst Phototechnik Digital Technlogy GmbH, Lienz (AT)

(72) Inventor: Peter Weingartner, Dolsach (AT)

(21) Appl. No.: 14/240,452

(22) PCT Filed: Oct. 18, 2012
(86) PCT No.: PCT/EP2012/004353

§ 371 Date: Feb. 24, 2014

(51) Int. Cl. B41J 25/00; B41J 2/01

(52) U.S. Cl. CPC B41J 25/001; B41J 2/01
USPC 347/37

(57) ABSTRACT

Method and device for printing the surface of a medium with an inkjet printer by performing several printing cycles. The printer includes a printing module with a printhead having a row of nozzles. A printing cycle includes:

a) positioning and aligning the printing module prior to printing, wherein the alignment is performed by rotation of the printing module around a rotation axis that is perpendicular on the part of the surface to be printed, and

b) positioning the rotation axis during printing.

The positioning process in steps b) includes translation of the rotation axis and defines a direction of travel. The printing module is aligned in step a) by rotation around the axis so that the row of nozzles has in step b) a predetermined and preferably constant angle in respect of the direction of travel. A predetermined workflow of printing cycles is different from a scanning technique.

The present invention relates to a method for printing the surface of a medium with ink by means of an inkjet printer. Inkjet printers (also called inkjet printing device) have at least one inkjet printhead with at least one row of nozzles arranged next to one another, through which the ink can be applied to the surface to be printed. The printing in this respect takes place by the expulsion of ink drops according to a prescribed and if necessary variable drop frequency. During the expulsion, the inkjet printhead executes a linear transverse movement, whereby a line is printed. The process known in the state of the art of printing line-by-line is also called scanning technique. For ink-jet printing, only the scanning technique is known to date if the printheads do not extend over the entire width of the medium to be printed. If the printhead travels only once over the line, this is called single scanning technique. If the printhead travels several times over the same line, it is called multi-scanning technique. Multi-scanning technique affords a higher printing quality, since the printing occurs from more than one direction (e.g. bi-directionally) and thus so-called “bending problems” can be minimized. Once a line has finished printing, the medium to be printed is moved by one line vertically to the transverse movement executed by the printhead in a direction of transport and the printing of the next line can begin. In this connection, there are mono-directional processes, i.e. the printhead prints only during the transverse movement in one direction and, having reached the end of the line, returns to the beginning of the line without printing. However, bidirectional processes also exist in which, once the end of the line has been reached, the medium to be printed is shifted by one line and the next line is already printed whilst the printhead returns to its initial position.

In the case of inkjet printing, the distance of the droplets applied during the printing determines the resolution. In the case of two-dimensional printing, the resolution in one dimension can differ from the resolution in the other dimension. For example, the resolution along the transverse movement of the printhead is determined by the speed of the printhead and the droplet expulsion frequency, whilst the resolution in the direction of transport is determined by the distance of the nozzles in the row of nozzles of the printhead. It must be noted in this respect that tilting the row of nozzles can increase this resolution.

By comparison with offset printing, the printing speeds of inkjet printers are considerably lower than those for example of offset printing devices. In order to increase this printing speed, it is known to provide the inkjet printer with a plurality of inkjet printheads.

A problem causing the slow printing speed is the fact that in the inkjet printers known nowadays, merely the line-by-line printing method described above is implemented. There are images for which nearly every line contains areas to be printed and areas that are not to be printed (print-free areas). If one nozzle of the printhead is driven over a free area of a line, it will not expel any ink. The frequent idling periods that thus arise cost a lot of time. This is then relevant if patterns and/or images with characteristic lines and light or dark surfaces are to be printed.

It would therefore be desirable for a method to be available, with which the above-mentioned idling periods can be reduced in order to achieve higher printing speeds.

The present invention has the task of providing a printing method for inkjet printers, with which the above-mentioned idling periods can be substantially avoided, whereby the printing speed can be considerably increased.

The task is solved with the procedure according to the method of claim 1. The dependent claims describe preferred embodiments of the present inventive method.

Printing cycle, in the framework of the present invention, subsumes those steps of the printing process that are performed before and within a drop expulsion period. A drop expulsion period in this respect begins directly after a drop expulsion from one nozzle and ends with the conclusion of the next subsequent drop expulsion out of the nozzle.

When in the framework of this description mention is made of positioning, this does not only mean the resting arrangement in a fixed position, The notion of positioning should also by all means include the approaching movement over a certain position.

When in the framework of this description mention is made of alignment, this relates to the rotation of the row of nozzles around the rotation axis, in case such a rotation is necessary. If no rotation is necessary, in order to achieve the inventive orientation of the row of nozzles, the rotation by 0° is also understood as aligning resp. alignment.

According to the invention, the procedure is that the line-by-line printing is abandoned and the printhead is driven along characteristic lines of the image or figure to be printed. The printhead is thus moved in two dimensions relative to the medium to be printed and essentially covers only those areas that are also effectively to be printed. This results in a strong reduction of the idling periods described above and the printing speed increases many times over. In this connection, incidentally, it does not matter whether in fact only the printhead is moved in two dimensions or the medium to be printed is moved in two dimensions or a combination of the movement of printhead and medium is used. What is essential is merely the free relative movement of the printhead relative to the surface to be printed, so that the characteristic lines and surfaces of the image to be printed can be followed.

In this approach, however, the problem is that in order to achieve a good printing quality, the printing resolution mentioned above must be controlled in both dimensions and must be capable for example of being maintained constant. According to the invention, this is achieved in that the printing module is executed to be rotatable around an axis, wherein the rotation axis is essentially vertical on the surface of the medium to be printed in the position currently to be printed. In this manner, the orientation of the row of nozzles of the printhead can be adjusted by rotating the printhead around the rotation axis.

If the printhead, and with it the mentioned rotation axis, is then moved following the characteristic lines of the image to be printed in both dimensions over the surface to be printed, the effective translation movement of the rotation axis will result in a current direction of travel. According to the invention, the printing is done in that the row of nozzles during the printing process is aligned in such a way that it maintains a predetermined and preferably constant angle to the current direction of travel.

If the angle, the printing frequency and the speed of travel are kept constant, it is possible in this manner to guarantee that along the printed lines resp. bands the ink drop density remains constant even during changes of direction. The ink drop density in the direction of travel can naturally be different from the ink drop density transverse to the direction of travel. In the process, the angle of the row of nozzles to the direction of travel determines the resolution transverse to the direction of travel. The speed of travel and the print frequency on the other hand determine the resolution along the direction of travel.

The invention will now be described in detail and by way of example on the basis of the figures.

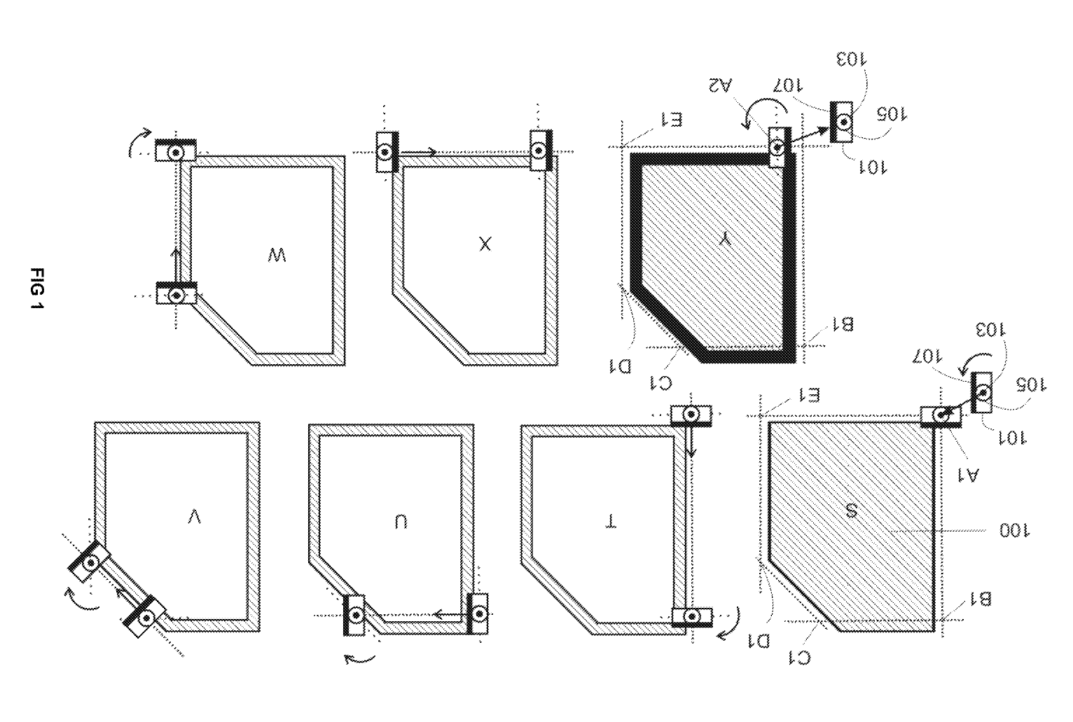

FIG. 1 shows a diagrammatic representation of the process steps S to Y for printing a medium according to the inventive method as viewed from above.

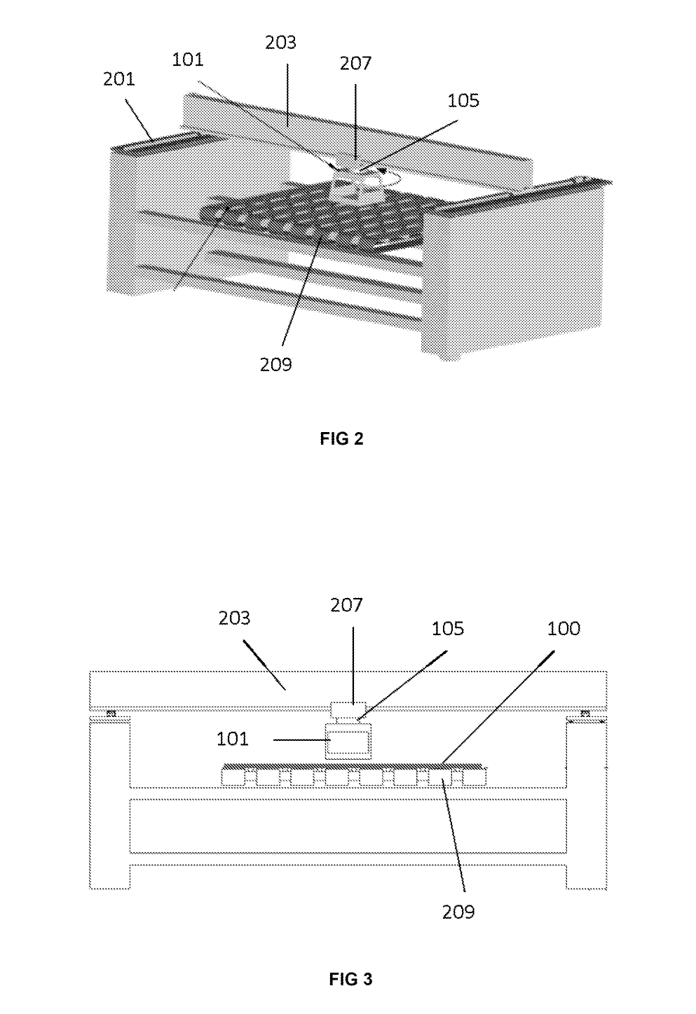

FIG. 2 shows a perspective representation of a preferred embodiment of the inkjet printing device.

FIG. 3 shows a perspective representation of the preferred embodiment of the inkjet printing device in a side view.

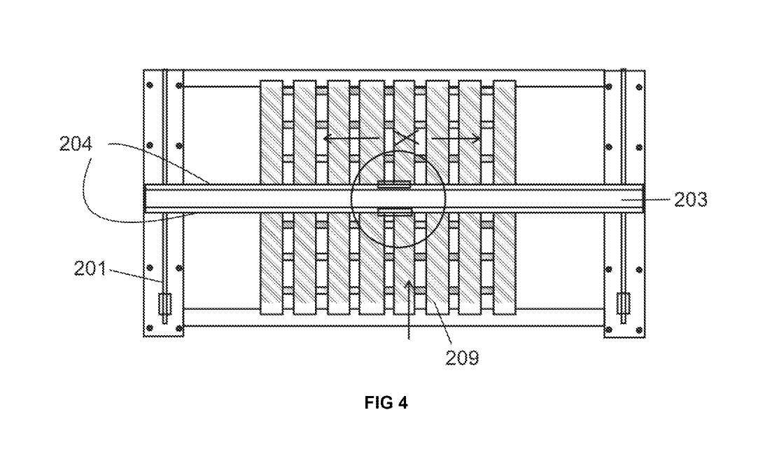

FIG. 4 shows a perspective representation of the preferred embodiment of the inkjet printing device as viewed from above.

In FIG. 1, the representations (S-Y) show by way of example the individual steps for printing the margin areas of the medium 100. In this example, reference is often made to the method steps a) or b); this means the method steps according to claim 1.

It is clear in this connection that a control unit controls the inkjet printer for the electronically stored image. According to the invention, the control unit computes for a particular image the optimum printing workflow, i.e. the temporally shortest printing process. This is achieved in that for example in a first step the control unit divides the image to be printed into virtual portions. In a second step, the arrangement and size of all virtual portions of the image are taken into account for computing an optimum printing process according to the method steps a) and b) of claim 1.

For computing the optimum printing process, the intersection points (A1 B1, C1, D1) and the characteristic lines (A1B1, B1C1, . . . see FIG. 1) are determined. The method step a) is executed at an intersection and the method step b) at the characteristic lines.

FIG. 1 contains the individual method steps S to Y that shall now be disclosed in detail.

Representation S:
In a first method step a), the printing module 101 is positioned and aligned from a parking position to a point A1.

Representation T:
In a method step b), the printing module 101 is driven from a point A1 to a point B1 along the characteristic (dotted) line A1B1 in a linear movement, whilst the margin area is being printed.
In the position B1, the printing module 101 is aligned according to method step a) in such a manner that in a further method step b) the margin area along the characteristic line B1C1 can be printed.

In the representation according to U to Y, the same process as for step T is followed.

A printhead has been disclosed in the description so far that comprises a row of nozzles 107, which maintains a predetermined angle with respect to a current direction of travel.

For multicolored printing, the corresponding printhead however typically comprises at least one row of nozzles per ink color for each of the ink colors used. According to a particularly preferred embodiment of the present invention, it is possible in respect of the current direction of travel to choose an angle associated with the ink color for several or each of these rows of nozzles independently from one another. In this manner, different angles—and thus resolutions—can be chosen for different ink colors.

A method for printing at least part of the surface of a medium 100 with an inkjet printer by performing a plurality of printing cycles has been disclosed, wherein the inkjet printer comprises a printing module 101 with at least one printhead with at least one row of nozzles 107, and wherein a printing cycle respectively comprises the following steps:

a) Positioning and aligning the printing module 101 prior to printing, wherein the alignment is performed by rotation of the printing module 101 around a rotation axis 103 that is perpendicular on the part of the surface to be printed.

b) Positioning the rotation axis 103 during printing of the part of the surface by expulsion of ink drops, according to the invention the translation movement of the rotation axis 103 associated in step b) with the positioning process a current direction of travel, and wherein the printing module 101 is aligned respectively in step a) of a printing cycle through rotation around said rotation axis 103 in such a manner that the at least one row of nozzles 107 of the at least one printhead has in step b) a predetermined and preferably constant angle in respect of the direction of travel.

The printing of the at least one part of the surface can be done with single scanning technique and/or with multi-scanning technique.

The printing of the at least one part of the surface can take place mono-directionally and/or bi-directionally or multi-directionally.

The positioning and alignment of the printing module 101 according to step a) can take place simultaneously or at different times.

The movement associated in step a) with the positioning of the printing module 101 can be performed in one, two or three dimensions.

The printing cycles take place according to a predetermined printing workflow that is different from the scanning technique.

The printing process for printing the at least one part of the surface can be pre-specified, i.e. the printing process for a particular image can be retrieved from a file, or it can be determined by a control unit resp. a processing unit.

In order to determine the printing sequence (=printing process), the control unit resp. processing unit in a first step divides the at least one part of the surface into virtual portions and in a second step, the parameters of all virtual portions are taken into account for computing the printing process according to the method steps a) and b).

The parameters in this respect relate to an arrangement and/or a position and/or a length and/or a width of the virtual portions.

For computing the printing process, intersection points for the method step a) and characteristic lines for the method step b) are determined, according to which the printing process is accomplished.

An inventive inkjet printer comprises a printing module 101 and a positioning device which is designed in such a way for the printing module 101 and a medium 100 with a surface to be printed to be movable in two dimensions relative to one another in a predetermined manner at a constant distance of the printing module 101 from the surface, wherein the printing module 101 has at least one printhead with at least one row of nozzles 107, characterized in that on the printing module 101 means 105 are provided for rotating the at least one row of nozzles 107 around a rotation axis 103 and which is vertical on the portion of the surface to be printed and through which rotating means 105 an alignment of the row of nozzles 107 can be performed by rotation.

The positioning device can include a linear guide system that has at least two guide rails 201 and at least one crossbar 203 provided with guide elements in the travel direction of the guide rails and that can be driven in motion, wherein the guide rails 201 are designed for moving the crossbar 203 in a predetermined manner in one and two directions.

The crossbar 203 can include a linear guide system that has at two guide rails 204 and at least print carriage 207 provided with guide elements in the travel direction of the guide rails and that can be driven in motion, wherein the guide rails 204 are designed for moving the print carriage 207 relative to the one-dimensional direction of movement of the crossbar 203 in a predetermined manner bi-directionally in a second dimension.

The print carriage 207 can include a linear guide system that is designed to be able to move the printing module 101 and the rotating means 105 relative to the direction of movement of the crossbar 203 and of the print carriage 207 in a predetermined manner bi-directionally in a third dimension, so that the height of the printing module 101 relative to the medium 100 is movably adjustable in a direction vertical to the medium 100.

The rotating means 105 can include a stepping motor.

The positioning device can include at least one transport belt 209 to transport the medium 100 below the printing module 101 in at least one direction of transport.

The inkjet printer can comprise a control unit for executing the inventive method.

What is claimed is:

1. A method for printing at least part of the surface of a medium (100) with an inkjet printer by performing a plurality of printing cycles, wherein the inkjet printer comprises a printing module (101) with at least one printhead with at least one row of nozzles (107), and wherein a printing cycle respectively comprises the following steps:
a) positioning and aligning the printing module (101) prior to printing, wherein the alignment is performed by rotation of the printing module (101) around a rotation axis (103) that is perpendicular on the part of the surface to be printed,
b) positioning the rotation axis (103) during printing of the part of the surface by expulsion of ink drops,
wherein the translation movement of the rotation axis (103) associated in step b) with the positioning process defines a current direction of travel, and wherein the printing module (101) is aligned respectively in step a) of a printing cycle through rotation around said rotation axis (103) in such a manner that the at least one row of nozzles (107) of the at least one printhead has in step b) a predetermined and preferably constant angle in respect of the direction of travel,
with the printing method being characterized in that the printing cycles take place according to a predetermined printing workflow that is different from the scanning technique.

2. Method according to claim 1, characterized in that the printing of the at least one part of the surface can be done with single scanning technique and/or with multi-scanning technique.

3. Method according to claim 1, characterized in that the printing of the at least one part of the surface can take place mono-directionally and/or bi-directionally or multi-directionally.

4. Method according to claim 1, characterized in that The positioning and alignment of the printing module (101) according to step a) can take place simultaneously or at different times.

5. Method according to claim 1, characterized in that the movement associated in step a) with the positioning of the printing module (101) can be performed in one, two or three dimensions.

6. (canceled)

7. Method according to claim 1, characterized in that the printing process for printing the at least one part for a particular image can be retrieved from a file resp. it can be determined by a processing unit.

8. Method according to claim 7, characterized in that the control unit resp. processing unit in a first step divides the at least one part of the surface into virtual portions and in a second step, the parameters of all virtual portions are taken into account for computing the printing process according to the method steps a) and b).

9. Method according to claim 8, characterized in that the parameters relate to an arrangement and/or a position and/or a length and/or a width of the virtual portions.

10. Method according to claim 9, characterized in that for computing the printing process, intersection points for the method step a) and characteristic lines for the method step b) are determined, according to which the printing process is accomplished.

11. Inkjet printer comprising a printing module (101) and a positioning device which is designed in such a way for the printing module (101) and a medium (100) with a surface to be printed to be movable in two dimensions relative to one another in a predetermined manner at a constant distance of the printing module (101) from the surface, wherein the printing module (101) has at least one printhead with at least one row of nozzles (107), wherein on the printing module (101) means (105) are provided for rotating the at least one row of nozzles (107) around a rotation axis (103) and which is vertical on the portion of the surface to be printed and through which rotating means (105) an alignment of the row of nozzles (107) can be performed by rotation, characterized in that the inkjet printer comprises a control unit for executing a method according to claim 1.

12. Inkjet printer according to claim 11, characterized in that the positioning device includes a linear guide system that has at least two guide rails (201) and at least one crossbar (203) provided with guide elements in the travel direction of the guide rails and that can be driven in motion, wherein the guide rails (201) are designed for moving the crossbar (203) in a predetermined manner in one and two directions.

13. Inkjet printer according to claim 12, characterized in that the crossbar (203) can include a linear guide system that has at two guide rails (204) and at least print carriage (207) provided with guide elements in the travel direction of the guide rails and that can be driven in motion, wherein the guide rails (204) are designed for moving the print carriage (207) relative to the one-dimensional direction of movement of the crossbar (203) in a predetermined manner bi-directionally in a second dimension.

14. Inkjet printer according to claim 13, characterized in that the print carriage (207) can include a linear guide system that is designed to be able to move the printing module (101) and the rotating means (105) relative to the direction of movement of the crossbar (203) and of the print carriage (207) in a predetermined manner bi-directionally in a third dimension, so that the height of the printing module (101) relative to the medium (100) is movably adjustable in a direction vertical to the medium (100).

15. Inkjet printer according to claim 11, characterized in that the rotating means (105) includes a stepping motor.

16. Inkjet printer according to claim 11, characterized in that the positioning device includes at least one transport belt (209) to transport the medium (100) below the printing module (101) in at least one direction of transport.

17. (canceled)
